(19) United States
(12) Patent Application Publication
(10) Pub. No.: US 2005/0281918 A1
(43) Pub. Date: Dec. 22, 2005

(54) Mineral composition using marine water

(75) Inventors: Hiroshi Shibata, Osaka (JP); Mie Hata, Foster City, CA (US); Hiroaki Sasaki, Kyoto (JP); Hiroshi Kono, Osaka (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SUNTORY LIMITED, Osaka-shi (JP)

(21) Appl. No.: 10/523,805

(22) PCT Filed: Aug. 8, 2003
(86) PCT No.: PCT/JP03/10161

§ 371 Date: Jul. 29, 2005

(30) Foreign Application Priority Data
Aug. 9, 2002 (JP) 2002-232809

(51) Int. Cl. A23L 1/30

(52) U.S. Cl. 426/72

(57) ABSTRACT

A seawater mineral component-containing composition is produced which contains mineral components having a good effect on health, such as magnesium and calcium, has a decreased content of sodium, and thus can be used widely for foods. When processed, the seawater mineral component-containing composition provides foods and beverages useful for preventing cardiovascular diseases and lifestyle-related diseases. The seawater mineral component-containing composition is obtained by subjecting seawater to electrodialysis, and has a sodium concentration of 6 mg/L or less when adjusted to form an aqueous solution having a hardness of 100 (EDTA method).

### TECHNICAL FIELD

This invention relates to a low-sodium seawater mineral component-containing composition from seawater, and foods and beverages containing the composition.

### BACKGROUND ART

In recent years, mortality rates due to heart diseases or malignant neoplasms(cancer) have increased as a result of the westernization of diet and changes in social environment. Factors, such as excessive nutritional intake, unbalanced diet, lack of exercise, stress, and lack of sleep, may interact to cause cardiovascular disorders deteriorating bloodstream, such as hyperlipidemia, hypertension, and arteriosclerosis. As a result, a heavy load may be imposed on the heart, causing ischemic heart disease.

Anxiety about such lifestyle-related diseases and a health-consciousness have led consumers to move to decrease their ingestion of sugars and fats, and to actively take in minerals, which tend to be lacking in processed foods, from supplements or health foods. Thus, the health foods market is rapidly expanding.

Research into mineral intake has resulted in a report in Japan which states that epidemiologically, heart diseases are less frequent in hard water districts and more frequent in soft water districts (Kobayashi J. et al. Ber Ohara Inst 11, 12-21(1957)), and another report stating that in the United States, the Ca/Mg ratio in drinking water and diets has a close positive correlation with annual mortality rates due to ischemic heart disease (Karppanen H. et al. Adv Cardiol 25, 9-24(1978)). Further, recent literature discusses the relation between cardiovascular diseases, including cerebrovascular diseases, and the Na.Ca/K.Mg ratio as a risk factor for them (Itogawa, Saishin Mineral Eiyo-gaku (Latest Mineral Nutrition), 60-72). Thus, attention has been drawn to the importance of a balanced mineral intake for maintaining and improving health.

The Japanese population has continued excessive intake of sodium (calculated as sodium chloride: about 12 g/day; the Status Quo of National Nutrition, the year 2000, Results of National Nutrition Surveys, Health Service Bureau, Ministry of Health, Labour and Welfare) resulting from their general eating habits, whereas a sodium chloride intake of less than 10 g/day is a target to be achieved (Effective Use of Sixth Revised Dietary Allowances for the Japanese—Diet Intake Standards—Health Service Bureau, Ministry of Health and Welfare). This does not refer to an appropriate intake, but rather means that salt should be reduced by about 3 g/day; excessive salt reduction would be risky for the Japanese population due to the relatively high amounts of sodium chloride habitually consumed. Past epidemiological studies have showed a positive correlation between salt intake and the incidence of hypertension and stroke (Itogawa, Latest Mineral Nutrition, 75). Thus, excessive intake of sodium is problematical from the point of view of preventing lifestyle-related diseases. Potassium intake sufficiently meets the dietary allowances even at the present time.

Calcium is an important mineral for the human body, but currently, its average intake is below the recommended dietary amount. Calcium is a mineral essential for the formation and maintenance of bones and teeth, and its average intake exceeded 500 mg in 1970, but is now lacking by about 50 mg/day (the Status Quo of National Nutrition, the year 2000, Results of National Nutrition Surveys, Health Service Bureau, Ministry of Health, Labour and Welfare). If a protein-rich diet is given to a rat in a calcium deficient state, the calcium concentration of its bone mineral content decreases (Takeda T. et al. J Nutr Sci Vitaminol 39, 355(1993)). Phosphorus and sodium are contained in large amounts in processed foods. For the present population, therefore, it is very important not only to reduce the intake of phosphorus and sodium, but also to have an appropriate intake of calcium.

The Japanese population is also deficient in magnesium by as much as about 150 mg/day (Emiko Kimura, Magnesium (edited by Yoshinori Itogawa and Noboru Saito), 81 (1995)). In animal experiments, elevation of blood pressure, increases in blood lipids (Kimura M. et al. Therapeutic Res 12(9), 2759-2773 (1991)) and diminution of the blood vessel caliber (Altura B M. et al. Science 223, 1315 (1984)) due to a deficiency of magnesium are known, and supplementation of magnesium is considered to be crucial in preventing these diseases.

Mineral water was originally prevalent in districts where unboiled water was not potable, such as Europe. Recently in Japan, there has been increased demand for the purchase of water, which is good for health and tasty to drink, due to a deterioration in the quality of tap water, and an increase in health-consciousness. At present, in connection with mineral water, the Ministry of Health, Labour and Welfare has established standards for source water, while the Ministry of Agriculture, Forestry and Fisheries of Japan has set up guidelines for classifying mineral water into four types according to differences in the method of treatment.

Generally, “soft water” is defined as water having a hardness of less than 100, and “hard water” as water having a hardness of 100 or more. Most tap water in Japan and commercially available mineral water products come in the category of soft water. Soft water does not contain adequate amounts of mineral components, and ingestion of mineral components from soft water has its limits.

Seawater, on the other hand, has a mineral composition which has a high correlation with the composition of human serum (Haraguchi et al., Gendai-Kagaku, July Issue, 16-22 (2000)). Unlike surface seawater, deep seawater is only minimally susceptible to environmental pollution, and undergoes mineral utilization by marine organisms. Deep seawater is highly clean and rich in minerals, and many products utilizing its mineral characteristics have been developed. Many disclosures of its applications have also been offered (Japanese Unexamined Patent Publication Nos. 2000-295974, 2001-136942, 2001-211864 and 2001-87762).

A prevalent method for producing mineral components from seawater is electrodialysis, which finds wide use as a salt producing process replacing the classical salt farm method. According to this method, called electrodialysis, seawater is flowed between cationic membranes and anionic membranes arranged alternately, and a direct electric current is passed between electrodes placed at either end. As a result, ionized substances in the liquid are separated, depending on their nature, such that cations migrate to the cathode, and anions migrate to the anode. The cations can pass through the cationic membrane, but the anions cannot pass through the cationic membrane. Using this principle, concentration compartments and dilution compartments are alternately formed in spaces interposed between the membranes, and a seawater concentrate having a salt concentration of 7 to 8 times as high as that of seawater is formed in the concentration compartment. If a membrane permeable to monovalent ions, but least permeable to divalent ions is selected as the exchange membrane, ions such as those of magnesium and calcium remain in the dilution compartment, without being able to enter the concentration compartment. Since the resulting diluted water contains an abundance of minerals, it can be used as a mineral supplement beverage. Recently, the sale of mineral water derived from deep seawater as source water has been carried out on a commercial scale. At the present time, it is common practice to select a membrane that is highly selective for monovalent ion permeation as the ionic membrane, and dialyze seawater until the electrical conductivity of mineral water is 10 to 12 mS/cm (sodium concentration: about 500 ppm).

To obtain mineral components containing large amounts of calcium and magnesium by electrodialysis, monovalent cations contained in seawater are moved into the concentration compartment with the use of a monovalent-selective cation exchange membrane (monovalent cation selective dialysis membrane), while divalent ions, such as magnesium and calcium ions, are retained in a mineral compartment (the dilution compartment referred to above). If, at this time, the concentration of monovalent cations (mainly, sodium) remaining in the mineral compartment becomes low, the value of a flowing electric current becomes lower, and the efficiency of electrodialysis also decreases. If electrodialysis is performed until electrical conductivity in the mineral compartment is 10 to 12 mS/cm, as is generally done in salt making methods, divalent ions in the mineral compartment mostly remain without being dialyzed. With this method, however, the sodium ion concentration in the mineral compartment can be lowered only to that of the order of 500 ppm.

### DISCLOSURE OF THE INVENTION

The mineral composition of seawater very highly correlates with the mineral composition of human serum, and contains a high proportion of magnesium as compared with land water. Thus, seawater may be of great use to a modern population, which faces a problem of a magnesium deficiency, as a supply source from which in vivo constituent minerals, such as magnesium, can be efficiently taken in. With the above-described conventional electrodialysis method, however, mineral components including divalent ions can be acquired without difficulty, but the concentrations of sodium and divalent ions remaining in large amounts are variable. Furthermore, if electrodialysis is completed when electrical conductivity reaches 10 to 12 mS/cm, the resulting seawater mineral-containing composition is not fully depleted of sodium. Thus, the intake of the composition is limited for reasons of health, and useful seawater mineral components have not been utilized sufficiently effectively. Even if electrodialysis is continued under the above conditions unchanged, operation costs will increase, the composition of minerals will not stabilize, and the value of the product as a commodity will be so low as to be excluded from quality assurance. Moreover, saltiness and an impure taste due to monovalent ions such as sodium are not preferred when the product is used for foods or beverages, especially for drinking water. (The results of a survey show that consumers were not fully satisfied with the taste of existing mineral beverages having a hardness of 250 or higher (December 2001, a WEB survey conducted in users of our mineral water).

Under these circumstances, we, the present inventors, conducted in-depth studies of seawater mineral components, which are safe and which have an excellent taste, in an attempt to provide useful seawater mineral components for wide use in foods and beverages. These studies led us to acquire a mineral-containing composition having a low sodium concentration, a high magnesium concentration, and a stable mineral composition, thereby accomplishing the present invention.

The present invention is a seawater mineral component-containing composition which is obtained by subjecting seawater to electrodialysis, and which, when adjusted to form an aqueous solution having a hardness of 100 (EDTA method), has a sodium concentration of 6 mg/L or less.

The present invention is also a food or beverage containing a seawater mineral component-containing composition which is obtained by subjecting seawater to electrodialysis, and which, when adjusted to form an aqueous solution having a hardness of 100 (EDTA method), has a sodium concentration of 6 mg/L or less.

The present invention is also a method for producing a seawater mineral component-containing composition by subjecting seawater to electrodialysis, wherein the electrodialysis is performed, using a monovalent cation-selective dialysis membrane, until an electric conductivity of less than 10 mS/cm is reached.

The present invention is also a method for producing a seawater mineral component-containing composition by subjecting seawater to electrodialysis, wherein the electrodialysis is performed a plurality of times.

Moreover, the present invention is a method for producing a seawater mineral component-containing composition, wherein in the electrodialysis, the sodium concentration in a concentration compartment is maintained low.

The seawater mineral component-containing composition of the present invention can be utilized widely as a food or beverage or its additive, may be used in the form of mineral water as such, or may be used in a form, such as a dry product, concentrate or dilution thereof, or a form such as any of these materials to which additives, for examples, vitamins, polyphenols, amino acids, peptides, proteins, sugars, fibers, and organic acids, have been added. The dry product can be produced by freeze-drying mineral water or its concentrate by an ordinary method; evaporating mineral water or its concentrate to dryness by an ordinary method; or including mineral water or its concentrate in a base material for powder formation, such as a sugar, followed by spray drying the resulting inclusion compound, by ordinary methods.

As the seawater usable in the present invention, surface seawater, intermediate seawater or deep seawater can be named. Of them, deep seawater, particularly seawater at a depth of 200 m or more, is minimally susceptible to environmental pollution, and thus is highly clear. Moreover, this type of water has its minerals minimally utilized by marine organisms. Thus, its minerals are maintained in abundance, so that this water is preferred for utilization in the present invention.

The seawater mineral components of the present invention are extremely stable as a composition. Thus, the seawater mineral component-containing composition, when used as such, or when used for foods or beverages containing the seawater mineral component-containing composition, may be subjected to treatment, such as heating, cooling or freezing. Foods and beverages, in which the seawater mineral component-containing composition can be used, may be any foods and beverages, without being limited to ordinary foods and beverages. For example, the seawater mineral component-containing composition can be used in the form of a supplement, such as capsules, tablets, a powder, or jelly, or in the form of ordinary foods and beverages. Their examples are fruit juice drinks, soft drinks, lactic acid bacteria drinks, carbonated drinks, coffee drinks, tea drinks, vegetable beverages, liqueurs, cocktails, shochu (distilled spirits), chuhai (shochu with carbonated water, sometimes flavored), wine, beer, sparkling wine or beer-like beverages, whiskey, brandy, tablets, candies, gummy candies, cookies, and jelly.

The seawater mineral component-containing composition of the present invention is excellent in taste, and very low in sodium concentration. When applied to the above-mentioned foods and beverages, therefore, it can be formed into wide varieties of food and drink products. By this means, it becomes possible to adjust the contents of mineral components, such as magnesium and calcium, in foods and beverages. The amount of the seawater mineral component-containing composition used can be set in conformity to the shape of the food or beverage provided. For example, products can be designed, with magnesium intake as an indicator. In this case, the product can be prepared such that a single intake of magnesium is 1 mg to 700 mg.

Furthermore, the seawater mineral component-containing composition of the present invention is high in its proportions of mineral components effective for health, such as magnesium and calcium, and is low in sodium concentration. Thus, it can be preferably used in foods and beverages such as low sodium diets and health foods.

For application to foods and beverages, the seawater mineral component-containing composition of the present invention may be applied in combination with other functional components. The other functional components are not restricted, but their examples include vitamins, polyphenols, amino acids, peptides, proteins, sugars, fibers, and organic acids.

The seawater mineral component-containing composition of the present invention is obtained by electrodialyzing seawater with the use of a monovalent cation-selective dialysis membrane. The electrodialysis can be carried out using an ordinary electrodialyzer. The electrical conductivity at completion of electrodialysis is adjusted to a low conductivity of less than 10 mS/cm, whereby there can be obtained a seawater mineral component-containing composition having a decreased sodium concentration, an increased magnesium concentration, and a stable mineral formulation. The preferred low conductivity is 8 mS/cm or less, especially 6 mS/cm, at completion of electrodialysis in consideration of the costs of water used and electric power used. When the electrical conductivity at completion of electrodialysis is set at a low conductivity, say, 6 mS/cm, a seawater mineral component-containing composition can be obtained which, when adjusted to form an aqueous solution having a hardness of 100 (EDTA method), has a sodium concentration of 4 mg/L or less, a magnesium concentration of 20 mg/L or more, and a magnesium/calcium weight ratio of 4 or higher.

As the monovalent cation-selective dialysis membrane, AC120 (ASAHI CHEMICAL INDUSTRY) or the like can be used.

The seawater mineral component-containing composition of the present invention may be produced by performing electrodialysis at least once with the use of a monovalent cation-selective dialysis membrane until an electrical conductivity of less than 10 mS/cm is reached. However, it may be acquired by a method performing electrodialysis a plurality of times in which mineral water, obtained by electrodialysis performed until an electrical conductivity (12 mS/cm) as in the ordinary salt manufacturing method is reached, is concentrated, and electrodialyzed again until the same electrical conductivity is reached.

Also, the sodium concentration in the concentration compartment in the electrodialyzer may be kept low to prevent reverse diffusion of sodium, whereby monovalent ions, such as sodium and potassium, can be stably removed to a maximum. Desirably, the sodium concentration in the concentration compartment is 20 mg/L or less, preferably 2 mg/L or less.

### EXAMPLES

Details of the present invention will be described concretely with reference to Examples, but the invention is not limited thereto.

### Example 1

### Method for Producing Secondary Mineral Water

Seawater at a depth of 330 m was electrodialyzed with the use of ASAHI CHEMICAL INDUSTRY's electrodialyzer (SV1/2 type) until the electrical conductivity at completion of electrodialysis reached 12 mS/cm. As a result, primary mineral water was obtained.

The primary mineral water (500 ml) was electrodialyzed with the use of ASAHI CHEMICAL INDUSTRY's electrodialyzer (S3 type) until the electrical conductivity reached 8 mS/cm or 6 mS/cm. As a result, secondary mineral water was produced. Table 1 shows the electrical conductivities and changes in the main minerals. As an electrodialysis membrane, ASAHI CHEMICAL INDUSTRY's AC120 type was used during each of primary mineral water production and secondary mineral water production. The temperature set at start of electrodialysis was 15° C., the electrical conductivity in the concentration compartment was 1.5 mS/cm, the circulating flow rate was 1.4 L/min, and the voltage was constant at 12.5V.

TABLE 1
Electrical conductivities and changes in sodium
concentration in electrodialysis

| | Electrical conductivity | | |
|---|---|---|---|
| | 12 mS/cm | 8 mS/cm | 6 mS/cm |
| Na (ppm) | 640 | 21 | 2 |
| Ca (PPm) | 310 | 192 | 122 |
| Mg (ppm) | 1300 | 820 | 736 |
| Hardness (mg/L) | 6105 | 3842 | 3322 |

### Example 2

### Method for Producing Mineral Beverages

The primary mineral water (12 mS/cm) and secondary mineral water (8 mS/cm, 6 mS/cm) described in Example 1 were each diluted with demineralized water (sodium concentration=1.8 mg/L), which had been obtained by treating seawater at a depth of 330 m with Dow Chemical's reverse osmosis membranes (SW30HR-380 (high pressure), SWLE-440 (low pressure), two stages). As a result, mineral water products of different hardnesses were prepared. Table 2 shows data on the mineral concentrations at the respective hardnesses.

The results showed that when electrical conductivity was set at a low value in electrodialyzing seawater, a seawater mineral component-containing composition having a decreased sodium concentration and an increased magnesium concentration could be obtained.

Furthermore, when electrodialysis was performed until the electrical conductivity reached 8 mS/cm, there was obtained a seawater mineral component-containing composition which, when adjusted to form an aqueous solution having a hardness of 100 (EDTA method), had a sodium concentration of 6 mg/L or less, a magnesium concentration of 20 mg/L or more, and a magnesium/calcium ratio of 4 or higher.

TABLE 2
Mineral compositions at respective hardnesses

| | | Conductivity | | |
|---|---|---|---|---|
| | Hardness | (1) (12 mS/cm) | (2) (8 ms/cm) | (3) (6 mS/cm) |
| Na (ppm) | 100 | 12.3 | 2.3 | 1.8 |
| | 250 | 27.9 | 3.0 | 1.9 |
| | 300 | 33.2 | 3.3 | 1.9 |
| | 350 | 38.4 | 3.5 | 1.9 |
| | 500 | 54.1 | 4.2 | 1.9 |
| | 1000 | 106.3 | 6.7 | 2.0 |
| Ca (ppm) | 100 | 5.1 | 5.0 | 3.7 |
| | 250 | 12.7 | 12.5 | 9.2 |
| | 300 | 15.2 | 15.0 | 11.0 |
| | 350 | 17.8 | 17.5 | 12.8 |
| | 500 | 25.4 | 24.9 | 18.3 |
| | 1000 | 50.8 | 49.9 | 36.7 |
| Mg (ppm) | 100 | 21.3 | 21.3 | 22.2 |
| | 250 | 53.2 | 53.4 | 55.4 |
| | 300 | 63.9 | 64.0 | 66.5 |
| | 350 | 74.5 | 74.7 | 77.5 |
| | 500 | 106.5 | 106.7 | 110.8 |
| | 1000 | 212.9 | 213.5 | 221.5 |

### Example 3

### Sensory Evaluation of Drinking Water Using Secondary Mineral Water

Sensory evaluation was performed for drinking water samples adjusted to hardnesses of 250, 300, 350, 500 and 1,000 in accordance with Example 2. The evaluations were made by 6 expert panelists, and the samples were evaluated for overall impression (as a basis for hedonic preference) and five taste characteristics. Each of the overall evaluation and the taste evaluations was performed on a scale of 5 grades.

(1) In the case of samples with hardness adjusted using the (12 mS/cm) mineral water, saltiness and sliminess were felt globally, and the higher the hardness, the stronger the bitterness and the impureness. Thus, the samples with a hardness of 300 and a hardness of 350 were assessed as “Slightly disliked” and “Disliked”, respectively, in the overall evaluation.

(2) In the case of samples with hardness adjusted using the (8 mS/cm) mineral water, samples with hardnesses of 250 and 300 were not felt salty, and were assessed as “Slightly liked” in the overall evaluation. Samples with a hardness of 350 were felt slightly salty and slimy, and were assessed as “Neither liked nor disliked”. Samples of higher hardnesses were felt salty, impure and slimy, and were assessed as “Not preferred”.

(3) In the case of samples with hardness adjusted using the (6 mS/cm) mineral water, samples with hardnesses of up to 300 were not felt salty or slimy, and were assessed as “Liked” in the overall evaluation. Samples with a hardness of 350 were assessed as “Slightly liked”. Samples with a hardness of 500 were assessed as “Neither liked nor disliked”. Samples with a hardness of 1,000 were felt salty, impure and slimy, and were assessed as “Slightly disliked”.

Based on the above results, the (8 ms/cm) mineral water (2) with a hardness of up to 350, and the (6 mS/cm) mineral water (3) with a hardness of up to 500 were confirmed to be superior to the (12 mS/cm) mineral water (1) in terms of taste.

Hence, the seawater-derived mineral water products having a low sodium concentration and a high magnesium concentration, which were obtained in Example 2, were found to be excellent in taste as compared with conventional seawater-derived mineral water products, and to be usable widely for various foods and beverages.

TABLE 3
Results of sensory evaluation of each sample

| | Evaluation | Mineral water | | |
|---|---|---|---|---|
| Hardness | items | (1) 12 mS/cm | (2) 8 mS/cm | (3) 6 mS/cm |
| 250 | Overall | 3 | 4 | 5 |
| | evaluation | | | |
| | Saltiness | 3 | 0 | 0 |
| | Sliminess | 3 | 0 | 0 |
| | Bitterness | 2 | 0 | 0 |
| | Impureness | 2 | 1 | 0 |
| | Difficulty in | 2 | 0 | 0 |
| | drinking | | | |
| 300 | Overall | 2 | 4 | 5 |
| | evaluation | | | |
| | Saltiness | 3 | 0 | 0 |
| | Sliminess | 3 | 1 | 0 |
| | Bitterness | 2 | 0 | 0 |
| | Impureness | 2 | 1 | 0 |
| | Difficulty in | 2 | 0 | 0 |
| | drinking | | | |
| 350 | Overall | 1 | 3 | 4 |
| | evaluation | | | |
| | Saltiness | 3 | 2 | 1 |
| | Sliminess | 3 | 1 | 0 |
| | Bitterness | 3 | 0 | 0 |
| | Impureness | 3 | 1 | 1 |
| | Difficulty in | 3 | 1 | 0 |
| | drinking | | | |
| 500 | Overall | 1 | 3 | 3 |
| | evaluation | | | |
| | Saltiness | 4 | 3 | 2 |
| | Sliminess | 3 | 3 | 1 |
| | Bitterness | 3 | 2 | 2 |
| | Impureness | 4 | 3 | 2 |
| | Difficulty in | 4 | 2 | 2 |
| | drinking | | | |
| 1000 | Overall | 1 | 1 | 2 |
| | evaluation | | | |
| | Saltiness | 4 | 4 | 3 |
| | Sliminess | 4 | 3 | 2 |
| | Bitterness | 4 | 4 | 2 |
| | Impureness | 4 | 4 | 2 |
| | Difficulty in | 4 | 4 | 2 |
| | drinking | | | |

Evaluation methods: Evaluations were made by 6 expert panelists. The overall evaluation was performed on the 5 following 5-grade scale: 5 (Liked), 4 (Slightly liked), 3 (Neither liked nor disliked), 2 (Slightly disliked), 1 (Disliked). The taste evaluation was performed on the following 5-grade scale: 4 (Strongly felt), 3 (Felt), 2 (Moderately felt), 1 (Slightly felt), 0 (Not felt).

### Example 4

Seawater-Derived Mineral Water (1,000 ml), which was obtained in Example 1 by electrodialysis performed until the electrical conductivity reached 6 mS/cm, was evaporated to dryness in an oven to obtain 5.5 g of a dry seawater mineral product.

### Example 5

### Method for Producing a Mineral-Containing Fruit Juice Drink

A fruit juice drink was produced in accordance with the following formulation:

| <Formulation> | <Proportion, % by weight> |
|---|---|
| Orange juice | 3.0 |
| Fructose, glucose, liquid sugar | 11.0 |
| Citric acid | 0.2 |
| L-Ascorbic acid | 0.05 |
| Seawater mineral component-containing | 8.0 |
| composition (*1) | |
| Flavoring material | 0. 15 |
| Pure water | Remainder |

(*1): Seawater-derived mineral water obtained in Example 1 by electrodialysis performed until the electrical conductivity reached 6 mS/cm or 8 mS/cm.

### Example 6

### Method for Producing a Mineral-Containing Soft Drink

A soft drink was produced in accordance with the following formulation:

| <Formulation> | <Proportion, % by weight> |
|---|---|
| Fructose, glucose, liquid sugar | 11.0 |
| Citric acid | 0.2 |
| Sodium L-aspartate | 0.005 |
| Monosodium L-glutamate | 0.005 |
| L-Ascorbic acid | 0.05 |
| Seawater mineral component-containing | 8.0 |
| composition (*2) | |
| Flavoring material | 0.15 |
| Pure water | Remainder |

(*2): Seawater-derived mineral water obtained in Example 1 by electrodialysis performed until the electrical conductivity reached 6 mS/cm or 8 mS/cm.

### Example 7

### Method for Producing a Mineral-Containing Milk Beverage

A milk beverage was produced in accordance with the following formulation:

| <Formulation> | <Proportion, % by weight> |
|---|---|
| Special-grade granulated sugar | 6.0 |
| Fructose, glucose, liquid sugar | 3.0 |
| Skim milk powder | 0.7 |
| Fermented milk | 4.0 |
| Pectin | 0.5 |
| L-Ascorbic acid | 0.05 |
| Seawater mineral component-containing | 8.0 |
| composition (*3) | |
| Pure water | Remainder |

(*3): Seawater-derived mineral water obtained in Example 1 by electrodialysis performed until the electrical conductivity reached 6 mS/cm or 8 mS/cm.

### Example 8

### Method for Producing a Mineral-Containing Carbonated Drink

A carbonated drink was produced in accordance with the following formulation:

| <Formulation> | <Proportion, % by weight> |
|---|---|
| Seawater mineral component-containing | 8.0 |
| composition (*4) | |
| Carbon dioxide | 0.5 |
| Pure water | Remainder |

(*4): Seawater-derived mineral water obtained in Example 1 by electrodialysis performed until the electrical conductivity reached 6 mS/cm or 8 mS/cm.

### Example 9

### Method for Producing a Mineral-Containing Coffee Drink

A coffee drink was produced in accordance with the following formulation:

| <Formulation> | <Proportion, % by weight> |
|---|---|
| Special-grade granulated sugar | 8.0 |
| Skim milk powder | 5.0 |
| Caramel | 0.2 |
| Coffee extract | 2.0 |
| Seawater mineral component-containing | 8.0 |
| composition (*5) | |
| Flavoring material | 0.1 |
| Pure water | Remainder |

(*5): Seawater-derived mineral water obtained in Example 1 by electrodialysis performed until the electrical conductivity reached 6 mS/cm or 8 mS/cm.

### Example 10

### Method for Producing a Mineral-Containing Tea Drink

A tea drink was produced in accordance with the following formulation:

| <Formulation> | <Proportion, % by weight> |
|---|---|
| Green tea | 0.8 |
| Powdered tea | 0.05 |
| L-ascorbic acid | 0.04 |
| Sodium bicarbonate | 0.02 |
| Flavoring material | 0.1 |
| Seawater mineral component-containing | 8.0 |
| composition (*6) | |
| Pure water | Remainder |

(*6): Seawater-derived mineral water obtained in Example 1 by electrodialysis performed until the electrical conductivity reached 6 mS/cm or 8 mS/cm.

### Example 11

### Method for Producing a Mineral-Containing Vegetable Beverage

A vegetable beverage was produced in accordance with the following formulation:

| <Formulation> | <Proportion, % by weight> |
|---|---|
| Mixed vegetable juice | 40.0 |
| Apple juice | 2.0 |
| Honey | 5.0 |
| Carrot puree | 8.0 |
| L-Ascorbic acid | 0.05 |
| Seawater mineral component-containing | 8.0 |
| composition (*7) | |
| Flavoring material | 0.15 |
| Pure water | Remainder |

(*7): Seawater-derived mineral water obtained in Example 1 by electrodialysis performed until the electrical conductivity reached 6 mS/cm or 8 mS/cm.

### Example 12

### Method for Producing a Mineral-Containing Liqueur

A liqueur (alcohol content 14%) was produced in accordance with the following formulation:

| <Formulation> | <Proportion, % by weight> |
|---|---|
| Brandy | 5.0 |
| Seawater mineral component-containing | 8.0 |
| composition (*8) | |
| Flavoring material | 0.15 |
| Pure water | Remainder |

(*8): Seawater-derived mineral water obtained in Example 1 by electrodialysis performed until the electrical conductivity reached 6 mS/cm or 8 mS/cm.

### Example 13

### Method for Producing a Mineral-Containing Chuhai (Shochu with Carbonated Water)

A chuhai was produced in accordance with the following formulation:

| <Formulation> | <Proportion, % by weight> |
|---|---|
| Spirit | 3.0 |
| Shochu | 25.0 |
| Seawater mineral component-containing | 8.0 |
| composition (*9) | |
| Citric acid | 0.5 |
| Flavoring material | 0.15 |
| Pure water | Remainder |

(*9): Seawater-derived mineral water obtained in Example 1 by electrodialysis performed until the electrical conductivity reached 6 mS/cm or 8 mS/cm.

### Example 14

### Method for Producing Mineral-Containing Tablets

Tablets were produced in accordance with the following formulation:

| <Formulation> | <Proportion, % by weight> |
|---|---|
| Glucose | 70.0 |
| Seawater mineral component-containing | 3.0 |
| composition (*10) | |
| Lactose | 20.45 |
| Gum arabic | 6.0 |
| L-ascorbic acid | 0.05 |
| Peppermint powder | 0.5 |

(*10): Dry seawater mineral product obtained in Example 4.

### Example 15

### Method for Producing Mineral-Containing Candies

Candies were produced in accordance with the following formulation:

| <Formulation> | <Proportion, % by weight> |
|---|---|
| Sugar | 45.0 |
| Glucose syrup | 51.0 |
| Seawater mineral component-containing | 3.0 |
| composition (*11) | |
| Flavoring material | 0.5 |
| Peppermint powder | 0.5 |

(*11): Dry seawater mineral product obtained in Example 4.

### Example 16

### Method for Producing Mineral-Containing Gummy Candies

Gummy candies were produced in accordance with the following formulation:

| <Formulation> | <Proportion. % by weight> |
|---|---|
| Powdered gelatin | 9.0 |
| Boiling water | 31.05 |
| Sugar | 24.0 |
| Glucose syrup | 32.5 |
| Seawater mineral component-containing | 3.0 |
| composition (*12) | |
| Peppermint powder | 0.45 |

(*12): Dry seawater mineral product obtained in Example 4.

### Example 17

### Method for Producing Mineral-Containing Cookies

Cookies were produced in accordance with the following formulation:

| <Formulation> | <Proportion, % by weight> |
|---|---|
| Soft flour | 32.0 |
| Whole egg | 16.0 |
| Margarine | 18.0 |
| White soft sugar | 25.5 |
| Seawater mineral component-containing | 2.5 |
| composition (*13) | |
| Baking powder | 0.2 |
| Water | Remainder |

(*13): Dry seawater mineral product obtained in Example 4.

### Example 18

### Method for Producing Mineral-Containing Jelly

A jelly was produced in accordance with the following formulation:

| <Formulation> | <Proportion, % by weight> |
|---|---|
| Granulated sugar | 15.0 |
| Gelatin | 5.0 |
| Orange extract | 5.0 |
| Seawater mineral component-containing | 1.5 |
| composition (*14) | |
| Peppermint powder | 0.4 |
| Pure water | Remainder |

(*14): Dry seawater mineral product obtained in Example 4.

### EFFECTS OF THE INVENTION

The seawater mineral component-containing composition of the present invention, which has stably increased proportions of mineral components effective for health, such as magnesium and calcium, and decreased contents of monovalent ions, such as sodium and potassium, can be used widely, as a seawater-derived mineral composition, for foods for which the amount of sodium incorporated matters, such as low salt diets and health foods. Also, the seawater mineral component-containing composition can solve the organoleptic problem of saltiness and impureness encountered when it is processed to form drinking water. From the aspect of effectiveness for health, the use of the mineral composition can provide, in many forms, foods and beverages which can be expected to be useful in preventing cardiovascular diseases or lifestyle-related diseases through the intake of magnesium and calcium.

1. A seawater mineral component-containing composition obtained by subjecting seawater to electrodialysis, said seawater mineral component-containing composition having a sodium concentration of 6 mg/L or less when adjusted to form an aqueous solution having a hardness of 100 (EDTA method).

2. A seawater mineral component-containing composition obtained by subjecting seawater to electrodialysis, said seawater mineral component-containing composition having a sodium concentration of 4 mg/L or less when adjusted to form an aqueous solution having a hardness of 100 (EDTA method).

3. The seawater mineral component-containing composition according to claim 1, having a magnesium concentration of 20 mg/L or more when adjusted to form an aqueous solution having a hardness of 100 (EDTA method).

4. The seawater mineral component-containing composition according to claim 1, having a magnesium/calcium weight ratio (Mg/Ca) of 4 or higher.

5. The seawater mineral component-containing composition according to claim 1, wherein said seawater is deep seawater.

6. The seawater mineral component-containing composition according to claim 5, wherein said deep seawater is seawater at a depth of 200 m or more.

7. The seawater mineral component-containing composition obtained by subjecting seawater to electrodialysis according to claim 1, wherein said electrodialysis is performed, using a monovalent cation-selective dialysis membrane, until an electric conductivity of less than 10 mS/cm is reached.

8. The seawater mineral component-containing composition obtained by subjecting seawater to electrodialysis according to any one claim 1, wherein said electrodialysis is performed a plurality of times.

9. The seawater mineral component-containing composition according to claim 7, wherein in said electrodialysis, a sodium concentration in a concentration compartment is maintained low.

10. A food or beverage containing the seawater mineral component-containing composition according to claim 1.

11. The seawater mineral component-containing composition according to claim 2, having a magnesium concentration of 20 mg/L or more when adjusted to form an aqueous solution having a hardness of 100 (EDTA method).

12. The seawater mineral component-containing composition according to claim 8, wherein in said electrodialysis, a sodium concentration in a concentration compartment is maintained low.
